(19) United States
(12) Patent Application Publication
(10) Pub. No.: US 2026/0352641 A1
(43) Pub. Date: Nov. 5, 2026

(54) MESSAGING FLOW FOR REMOTE INTERACTIONS USING SECURE DATA

(71) Applicant: Visa International Service Association, San Francisco, CA (US)

(72) Inventor: Yuexi Chen, Foster City, CA (US)

(73) Assignee: Visa International Service Association, San Francisco, CA (US)

(21) Appl. No.: 19/118,163

(22) PCT Filed: Oct. 5, 2023
(86) PCT No.: PCT/US2023/076060

§ 371 Date: Apr. 3, 2025

Related U.S. Application Data
(60) Provisional application No. 63/413,851, filed on Oct. 6, 2022.

(51) Int. Cl. H04L 9/40; H04L 9/32

(52) U.S. Cl. CPC H04L 63/0428; H04L 9/321; H04L 63/10

(57) ABSTRACT

A method is disclosed. The method includes receiving encrypted data from a user device operated by a user via a secure kernel on the communication device, after the user interacts with a resource provider computer in an interaction. The method also includes decrypting the encrypted data to recover access data, and a cryptogram, and then transmitting, to the resource provider computer, an interaction identifier and the access data or a derivative of the access data. The resource provider computer transmits an authorization request message comprising the access data or derivative thereof to an authorizing entity computer. The processing cloud computer transmits to the authorizing entity computer, the cryptogram. The authorizing entity computer receives the authorization request message and the cryptogram, and authorizes or declines the interaction based on data in the authorization request message and the cryptogram.

### CROSS-REFERENCE TO RELATED APPLICATIONS

This is a PCT application, which claims priority to U.S. Provisional Application No. 63/413,851, filed on Oct. 6, 2022, which is herein incorporated by reference in its entirety.

### BACKGROUND

In a typical transaction to gain access to a resource (e.g., a good or service, secure data, etc.) via a remotely located resource provider computer (e.g., via the Internet), a user will typically provide a credential (e.g., a password, an account number, etc.) to the resource provider computer to authenticate themselves to the resource provider computer.

However, the use of credentials as a sole means to obtain access to resources via remotely located computers is problematic. Such credentials can be stolen through hacking or social engineering.

In some cases, a user can interact a user device such as a card with a client terminal to access a resource via a remote computer. The user device in this situation often has additional security information on them (e.g., a shared secret, a cryptogram, etc.) which can make remote transactions more secure. Any unauthorized person would need to be in possession of the user device in order to successfully impersonate an authorized user in a transaction.

However, not all systems can accommodate the use of user devices in this manner. For example, a traditional e-commerce infrastructure that utilizes user entered data that is displayed on a card (e.g., a credit card) uses transaction messages that are unable to accommodate the additional security information that might be stored on the card. Such additional security information might be useful to downstream authorizing entity computers that authorize or decline e-commerce transactions.

Embodiments of the invention address these and other problems.

### SUMMARY

Embodiments of the invention are directed to token provisioning systems and methods.

One embodiment includes a method comprising: receiving, by a processing cloud computer, encrypted data from a user device operated by a user via a secure kernel on the communication device, after the user interacts with a resource provider computer in an interaction; decrypting, by the processing cloud computer, the encrypted data to recover access data, and a cryptogram; transmitting, by the processing cloud computer to the resource provider computer, an interaction identifier and the access data or a derivative of the access data, wherein the resource provider computer thereafter transmits an authorization request message comprising the access data or derivative thereof to an authorizing entity computer; and transmitting, by the processing cloud computer to the authorizing entity computer, the cryptogram, wherein the authorizing entity computer receives the authorization request message and the cryptogram, and authorizes or declines the interaction based on data in the authorization request message and the cryptogram.

Another embodiment of the invention includes a processing cloud computer comprising: a processor; and a computer readable medium. The computer readable medium comprises code executable by the processor, to perform operations comprising: receiving encrypted data from a user device operated by a user via a secure kernel on the communication device, after the user interacts with a resource provider computer in an interaction; decrypting the encrypted data to recover access data, and a cryptogram; and transmitting, to the resource provider computer, an interaction identifier and the access data or a derivative of the access data, wherein the resource provider computer thereafter transmits an authorization request message comprising the access data or derivative thereof to an authorizing entity computer; transmitting, to the authorizing entity computer, the cryptogram, wherein the authorizing entity computer receives the authorization request message and the cryptogram, and authorizes or declines the interaction based on data in the authorization request message and the cryptogram.

Another embodiment includes a method comprising: receiving, by an authorizing entity computer, an authorization request message from a processing network computer; receiving, by the authorizing entity computer in a communication, a cryptogram from a processing cloud computer, wherein the cryptogram as obtained from a user device operated by a user via a secure kernel on a communication device; validating, by the authorizing entity computer, the cryptogram; authorizing, by the authorizing entity computer, the authorization request message based in part on the validating of the cryptogram; and responsive to authorizing, transmitting, by the authorizing entity computer, an authorization response message to the processing network computer.

Yet another embodiment of the invention includes an authorizing entity computer comprising: a processor; and a computer readable medium. The computer readable medium comprises code, executable by the processor, for performing a method comprising: receiving an authorization request message from a processing network computer; receiving, in a communication, a cryptogram from a processing cloud computer, wherein the cryptogram as obtained from a user device operated by a user via a secure kernel on a communication device; validating the cryptogram; authorizing the authorization request message based in part on the validating of the cryptogram; and responsive to authorizing, transmitting an authorization response message to the processing network computer.

These and other embodiments of the invention are described in further detail below.

### BRIEF DESCRIPTION OF THE DRAWINGS

FIG. 1 shows a system diagram and a process flow according to an embodiment of the invention.

FIG. 2 shows the architecture of a processing cloud computer according to some embodiments.

FIG. 3 shows the architecture of a communication device according to an embodiment.

FIG. 4 shows a user device in the form of a card.

FIG. 5 shows an example of message exchange process of a communication device capturing access data and a cryptogram from a user device.

### DETAILED DESCRIPTION

Before discussing embodiments of the invention, some description of some terms may be helpful.

A “communication device” may comprise any suitable electronic device that may be operated by a user, which may also provide remote communication capabilities to a network. A “mobile communication device” may be an example of a “communication device” that can be easily transported. Examples of remote communication capabilities include using a mobile phone (wireless) network, wireless data network (e.g., 3G, 4G or similar networks), Wi-Fi, Wi-Max, or any other communication medium that may provide access to a network such as the Internet or a private network. Examples of mobile communication devices include mobile phones (e.g., cellular phones), PDAs, tablet computers, net books, laptop computers, personal music players, hand-held specialized readers, etc. Further examples of mobile communication devices include wearable devices, such as smart watches, fitness bands, ankle bracelets, rings, earrings, etc., as well as automobiles with remote communication capabilities. In some embodiments, a mobile communication device can function as a payment device (e.g., a mobile communication device can store and be able to transmit payment credentials for a transaction).

A “user device” may include a device that is used by a user. In some cases, a user device can be a payment device. The payment device may be a physical object. A payment device may comprise a substrate such as a paper or plastic card, and information that is printed, embossed, encoded, or otherwise included at or near a surface of an object. A payment device may be associated with a value such as a monetary value, a discount, or store credit, and a payment device may be associated with an entity such as a bank, a merchant, a payment processing network, or a person. Suitable payment devices can be hand-held and compact so that they can fit into a user's wallet and/or pocket (e.g., pocket-sized). Example payment devices may include smart cards, magnetic stripe cards, keychain devices (such as the Speedpass™ commercially available from Exxon-Mobil Corp.), etc.

Other examples of payment devices include payment cards, smart media, transponders, and the like. If the payment device is in the form of a debit, credit, or smartcard, the payment device may also optionally have features such as magnetic stripes. Such devices can operate in either a contact or contactless mode.

“Access data” may include any suitable data that can be used to access a resource or create data that can access a resource. In some embodiments, access data may be account information for a payment account. Account information may include a credential such as a PAN, payment token, expiration date, verification values (e.g., CVV, CVV2, dCVV, dCVV2), etc. In other embodiments, access data may be data that can be used to activate account data. For example, in some cases, account information may be stored on a mobile device, but may not be activated until specific information is received by the mobile device. In other embodiments, access data could include data that can be used to access a location. Such access data may be ticket information for an event, data to access a building, transit ticket information, etc. In yet other embodiments, access data may include data used to obtain access to sensitive data. Examples of access data may include codes or other data that are needed by a server computer to grant access to the sensitive data.

A “credential” may be any suitable information that serves as reliable evidence of worth, ownership, identity, or authority. A credential may be a string of numbers, letters, or any other suitable characters, as well as any object or document that can serve as confirmation. Examples of credentials include value credentials, identification cards, certified documents, access cards, passcodes, and other login information, etc.

“Payment credentials” may include any suitable information associated with an account (e.g., a payment account and/or payment device associated with the account). Such information may be directly related to the account or may be derived from information related to the account. Examples of payment credentials may include a PAN (primary account number or “account number”), user name, expiration date, and verification values such as CVV (card verification value), dCVV (dynamic card verification value), CVV2 (card verification value 2), CVC3 card verification values, etc. An example of a PAN is a 16-digit number, such as “4147 0900 0000 1234.” In some embodiments, payment credentials can include additional information that may be used for authorizing a transaction. For example, payment credentials can include a cryptogram associated with the transaction.

An “encryption key” may include any data value or other information suitable to cryptographically encrypt data. A “decryption key” may include any data value or other information suitable to decrypt encrypted data. In some cases, an encryption key and a decryption key may be the same (i.e., a “symmetric key”).

A “cryptogram” may include encrypted information. For example, a cryptogram can be a set of text encrypted with an encryption key.

A “secure kernel” is a software component of an operating system that manages interactions between hardware and software of the system. It may be specifically designed to securely store and manage sensitive data. A secure kernel may also handle a computer's hardware, timing, peripherals, memory, disks, and user access. The code that governs the secure kernel resides in a protected area of memory, separate from programs such as browsers, word processors, or other applications. This separation of user and kernel data can prevent unwanted behavior such as modification by an offending user program.

A “token” may be a substitute value for a credential. A token may be a string of numbers, letters, or any other suitable characters. Examples of tokens include payment tokens, access tokens, personal identification tokens, etc.

A “payment token” may include an identifier for a payment account that is a substitute for an account identifier, such as a primary account number (PAN). For example, a payment token may include a series of alphanumeric characters that may be used as a substitute for an original account identifier. For example, a token “4900 0000 0000 0001” may be used in place of a PAN “4147 0900 0000 1234.” In some embodiments, a payment token may be “format preserving” and may have a numeric format that conforms to the account identifiers used in existing transaction processing networks (e.g., ISO 8583 financial transaction message format). In some embodiments, a payment token may be used in place of a PAN to initiate, authorize, settle, or resolve a payment transaction or represent the original credential in other systems where the original credential would typically be provided. In some embodiments, a payment token may be generated such that the recovery of the original PAN or other account identifier from the token value may not be computationally derived. Further, in some embodiments, the token format may be configured to allow the entity receiving the token to identify it as a token and recognize the entity that issued the token.

“Tokenization” is a process by which data is replaced with substitute data. For example, a payment account identifier (e.g., a primary account number (PAN)) may be tokenized by replacing the primary account identifier with a substitute number (e.g., a token) that may be associated with the payment account identifier. Further, tokenization may be applied to any other information that may be replaced with a substitute value (i.e., token). Tokenization enhances transaction efficiency and security.

A “token domain” may indicate an area and/or circumstance in which a token can be used. Examples of token domains may include, but are not limited to, payment channels (e.g., e-commerce, physical point of sale, etc.), POS entry modes (e.g., contactless, magnetic stripe, etc.), and merchant identifiers to uniquely identify where the token can be used. A set of parameters (i.e., token domain restriction controls) may be established as part of token issuance by the token service provider that may allow for enforcing appropriate usage of the token in payment transactions. For example, the token domain restriction controls may restrict the use of the token with particular presentment modes, such as contactless or e-commerce presentment modes. In some embodiments, the token domain restriction controls may restrict the use of the token at a particular merchant that can be uniquely identified. Some exemplary token domain restriction controls may require the verification of the presence of a token cryptogram that is unique to a given transaction. In some embodiments, a token domain can be associated with a token requestor.

A “token expiry date” may refer to the expiration date/time of the token. The token expiry date may be passed among the entities of the tokenization ecosystem during transaction processing to ensure interoperability. The token expiration date may be a numeric value (e.g., a 4-digit numeric value). In some embodiments, the token expiry date can be expressed as a time duration as measured from the time of issuance.

A “user” may include an individual. In some embodiments, a user may be associated with one or more personal accounts and/or mobile devices. The user may also be referred to as a cardholder, account holder, or consumer in some embodiments.

A “resource provider” may be an entity that can provide a resource such as goods, services, information, and/or access. Examples of resource providers includes merchants, data providers, transit agencies, governmental entities, venue, and dwelling operators, etc.

A “merchant” may typically be an entity that engages in transactions and can sell goods or services, or provide access to goods or services.

An “acquirer” may typically be a business entity (e.g., a commercial bank) that has a business relationship with a particular merchant or other entity. Some entities can perform both issuer and acquirer functions. Some embodiments may encompass such single entity issuer-acquirers. An acquirer may operate an acquirer computer, which can also be generically referred to as a “transport computer.”

An “authorizing entity” may be an entity that authorizes a request. Examples of an authorizing entity may be an issuer, a governmental agency, a document repository, an access administrator, etc.

An “issuer” may typically refer to a business entity (e.g., a bank) that maintains an account for a user. An issuer may also issue payment credentials stored on a user device, such as a cellular telephone, smart card, tablet, or laptop to the consumer.

An “authorization request message” may be an electronic message that requests authorization for a transaction. In some embodiments, it is sent to a transaction processing computer and/or an issuer of a payment card to request authorization for a transaction. An authorization request message according to some embodiments may comply with ISO 8583, which is a standard for systems that exchange electronic transaction information associated with a payment made by a user using a payment device or payment account. The authorization request message may include an issuer account identifier that may be associated with a payment device or payment account. An authorization request message may also comprise additional data elements corresponding to “identification information” including, by way of example only: a service code, a CVV (card verification value), a dCVV (dynamic card verification value), a PAN (primary account number or “account number”), a payment token, a username, an expiration date, etc. An authorization request message may also comprise “transaction information,” such as any information associated with a current transaction, such as the transaction amount, merchant identifier, merchant location, acquirer bank identification number (BIN), card acceptor ID, information identifying items being purchased, etc., as well as any other information that may be utilized in determining whether to identify and/or authorize a transaction.

An “authorization response message” may be a message that responds to an authorization request. In some cases, it may be an electronic message reply to an authorization request message generated by an issuing financial institution or a transaction processing computer. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the transaction processing computer) to the merchant's access device (e.g., POS equipment) that indicates approval of the transaction. The code may serve as proof of authorization.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may comprise one or more computational apparatuses and may use any of a variety of computing structures, arrangements, and compilations for servicing the requests from one or more client computers.

One embodiment of the invention includes a method. The method includes receiving, by a processing cloud computer, encrypted data from a user device operated by a user via a secure kernel on the communication device, after the user interacts with a resource provider computer in an interaction. The method also includes decrypting, by the processing cloud computer, the encrypted data to recover access data and a cryptogram. The processing cloud computer then transmits to the resource provider computer, an interaction identifier and the access data or a derivative of the access data. The resource provider computer thereafter transmits an authorization request message comprising the access data or derivative thereof to an authorizing entity computer through a first communication path.

The resource provider computer may not be capable of incorporating the cryptogram from the user device in the authorization request message, because the authorization request messages that it typically generates can be for e-commerce type transactions that would not include user device-generated (e.g., card-generated) cryptograms. Thus, in embodiments of the invention, the processing cloud computer transmits to an authorizing entity computer, the cryptogram through a second communication path that is different than the first communication path. The authorizing entity computer receives the authorization request message and the cryptogram, and authorizes or declines the interaction based on data in the authorization request message and the cryptogram.

Embodiments of the invention have a number of technical advantages. In the above-described flow, the user-device generated cryptogram (and optionally other security data) can be delivered to an authorizing entity computer, even though the authorization request message that is sent by the resource provider computer to the authorizing entity computer is not formatted to carry the user-device generated cryptogram. As such, embodiments of the invention provide the authorizing entity computer with additional information that can be used to determine whether or not to authorize a transaction. Such information would otherwise not be available to the authorizing entity computer in conventional e-commerce transaction systems. In addition, the user need not pre-enroll with the transaction system in order to obtain the additional security provided by embodiments of the invention.

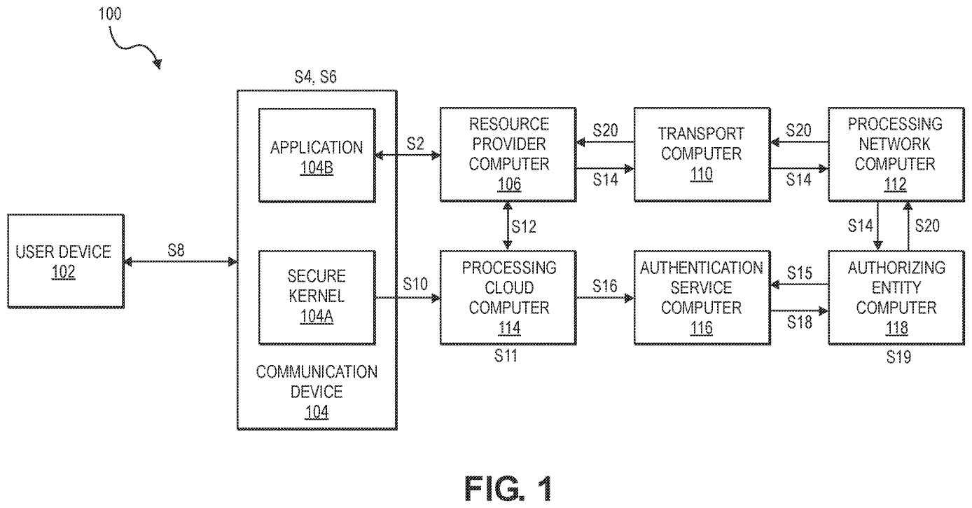

FIG. 1 shows a block diagram of a transaction flow and messaging system 100 according to an embodiment. The system 100 includes a user device 102, a communication device 104, a resource provider computer 106, a transport computer 110, a processing network computer 112, a processing cloud computer 114, an authentication server computer 116, and an authorizing entity computer 118. The communication device 104 can include a secure kernel 104A that is programmed to interact with the user device 102 and the processing cloud computer 114. The communication device 104 can also include an application 104B that is programmed to interact with the resource provider computer 106. Each of these systems and computers may be in operative communication with each other. For simplicity of illustration, a certain number of components are shown in FIG. 1. It is understood, however, that embodiments of the invention may include more than one of each component. In addition, some embodiments of the invention may include fewer than or greater than all of the components shown in FIG. 1. In addition, the components in FIG. 1 may communicate via any suitable communication medium (including the Internet), using any suitable communications protocol.

The resource provider computer 106 may be operated by or on behalf of a resource provider (e.g., a merchant) and the transport computer 110 may be operated by an acquirer (e.g., a financial institution) responsible for managing an account associated with the resource provider. The authorizing entity computer 118 may be operated by an issuer (e.g., another financial institution).

The processing network computer 112 may be in a processing network such as a payment processing network. The payment processing network is configured to provide authorization services, and clearing and settlement services for payment transactions. The processing network computer 112 may include data processing subsystems, networks, and operations used to support and deliver authorization services, exception file services, and clearing and settlement services. An exemplary payment processing network may include VisaNet™. Payment processing networks such as VisaNet™ are able to process credit card transactions, debit card transactions, and other types of commercial transactions. VisaNet™, in particular includes a Visa Integrated Payments (VIP) system which processes authorization requests and a Base II system which performs clearing and settlement services.

Methods according to embodiments of the invention can be described with respect to FIG. 1.

In step S2, a user interacts with a host site operated by a resource provider and initiates a remote e-commerce transaction using the communication device 104. The remote e-commerce transaction can sometimes be characterized as a “card-not-present” transaction. The user may shop and check out on a host site (e.g., a Website) on the resource provider computer 106 via the application 104B on the communication device 104. The application 104B may be a browser, or it may be a dedicated application. If it is a dedicated resource provider application, then the host site on the resource provider computer 106 may support the dedicated resource provider application.

In step S4, if the communication device 104 is equipped with near-field-communication capability, the host site operated on the resource provider computer 106 can cause the communication device 104 to render a checkout page/frame requesting that the user interact (e.g., tap) their user device 102 to the communication device 104 to complete the checkout process.

In step S6, the rendered checkout page/frame on the host site triggers the secure kernel 104A on the communication device 104 to start communicating with user device 102 that is in proximity to the communication device 104. The host site may provide a value for the interaction (e.g., a transaction amount) and other data related to the interaction (e.g., a resource provider identifier such as a merchant identifier, a timestamp, etc.) to the secure kernel 104A and/or the application 104B in the communication device 104.

In step S8, the secure kernel 104A transmits the value for the interaction and other data to the user device 102. The user device 102 can then generate a cryptogram by encrypting at least data (e.g., the value, the resource provider identifier, etc.) from the resource provider computer 108 and data (e.g., access data such as a PAN and expiration date) stored in the user device 102 using a cryptographic key that is shared with the authorizing entity computer 118. In some embodiments, the cryptogram can be formed by concatenating the data (e.g., the value, the resource provider identifier, etc.) from the resource provider computer 108 and data (e.g., access data such as a PAN and expiration date) stored in the user device 102, hashing the concatenated data, and the signing the hashed data (using an HMAC algorithm). The authorizing entity associated with the authorizing entity computer 118 may have provisioned the user device 102 with a cryptographic key (e.g., a symmetric key) before providing it to the user. The authorizing entity computer 118 may store or derive the corresponding cryptographic key. If it is derived, then the authorizing entity computer 118 connects to a HSM (Hardware security module) which stores a master key. The corresponding cryptographic key is derived from the master key using the credential (e.g., PAN).

In the interaction between the secure kernel 104A and the user device 102, the secure kernel 104A eventually receives the access data (e.g., PAN and expiration date) and the cryptogram (e.g., EMV Application Cryptogram) from the user device 102. Because the access data is provided by the user device 102, the user need not enter that data into the host site on the resource provider computer 106. This makes the interaction process more convenient and efficient for the user because fewer steps that need to be taken by the user to complete the interaction.

Prior to step S10, the secure kernel 104A establishes a first set of zone encryption keys with a processing cloud computer 114. The secure kernel 104A and the processing cloud computer 114 can share a first set of cryptographic keys using any suitable process including a Diffie-Hellman key exchange process. In a similar fashion, the processing cloud computer 114 and the resource provider computer 106 can establish a second set of zone encryption keys. The resource provider computer 106 and the processing cloud computer 114 can share a first set of cryptographic keys using any suitable process including a Diffie-Hellman key exchange process.

In step S10, the secure kernel 104A encrypts the access data and cryptogram that are received from the user device 102 using a first cryptographic zone key. In step S10, the communication device 104 transmits the encrypted data and also a resource provider computer identifier or address (e.g., a URL) to the processing cloud computer 114 and the processing cloud computer 114 receives the same.

In step S11, the processing cloud computer 114 uses a second cryptographic zone key corresponding to the first cryptographic zone key to decrypt the encrypted data and recover at least the access data and the cryptogram.

In step S12, after obtaining the access data and the cryptogram, the processing cloud computer 114 can generate a unique interaction identifier for the transaction. The processing cloud computer 114 can then encrypt the unique interaction identifier (e.g., transaction reference) and the access data or a derivative thereof with a second cryptographic zone key. The processing cloud computer 114 can then transmit the encrypted data to the resource provider computer 106. In some embodiments, the access data may be a credential such as a primary account number or PAN. In other embodiments, the access data can be a derivative of the credential such as a token. A token can be a substitute for a PAN. In some embodiments, the processing cloud computer 114 can receive a PAN and can tokenize the PAN to form a payment token and the payment token can be transmitted to the resource provider computer 106.

After the resource provider computer 106 receives the encrypted the access data or the derivative thereof, and the interaction identifier, the resource provider computer 106 can decrypt the encrypted data using a corresponding second zone encrypt key. Once decrypted, the resource provider computer 106 can extract the access data or the derivative thereof and the interaction identifier. The resource provider computer 106 can then initiate transaction authorization processing using the access data or derivative thereof.

In some embodiments, the processing cloud computer 114 may also transmit other information such as a name, shipping information, and contact information of the user to the resource provider computer 106. The resource provider computer 106 can use this information to populate the checkout page to make the checkout process more efficient. In this case, the user does not need to manually fill out the information during checkout on the host site on the resource provider computer 106, thus making the process more efficient for the user.

In step S14, the resource provider computer 106 sends the authorization request message to the authorizing entity computer 118 via the transport computer 110 and the processing network computer 112. The authorization request message may comprise a transaction amount, the interaction identifier, a merchant identifier, and access data or derivative thereof, but does not include the cryptogram that was generated by the user device 102. The authorization request message may be in the form of an ISO 8583 message and may include a card not present transaction or ecommerce indicator in it. Existing protocols and messages for e-commerce transactions cannot carry the cryptogram. As will be apparent from the description below, embodiments can use an existing e-commerce payment infrastructure while still providing the cryptogram to an authorizing entity computer 118.

In some embodiments, the authorization request message may comprise a token instead of a credential. If it does, then the processing network computer 112 can detokenize the token to obtain the credential. The processing network computer 112 can determine if the token is being used in the right domain. If it is, then the processing network computer 112 can transmit the authorization request message with the credential to the authorizing entity computer 118.

In step S15, once the authorizing entity computer 118 receives the authorization request message transmitted by the resource provider computer 106 via a transport computer 110 and a processing network computer 112, the authorizing entity computer 118 may verify the transaction with using the user device generated cryptogram. The authorizing entity computer 118 may transmit an authentication request to the authentication service computer 116.

In a conventional system, when an authorizing entity computer 118 receives an authorization request message in a card not present type of transaction, the authorizing entity computer 118 may request a step-up authentication of the user (e.g., requesting OTP from the user). Embodiments introduce a new messaging mechanism to replace existing methods for step-up authentication. The user device generated cryptogram can be transmitted to the authorizing entity computer 118 so that the authorizing entity computer 118 has additional proof that the transaction is authentic. Advantageously, the user does not need to provide additional authentication information after the transaction has been initiated. This is a technical advantage as the number of messages in embodiments of the invention can be less than in conventional systems.

In step S16, before or after the resource provider computer 106 transmits the authorization request message to the authorizing entity computer 118, the processing cloud computer 114 can extract (e.g., decrypt) the cryptogram from the encrypted data packet that is received from the secure kernel using a zone key that is shared with the secure kernel 104A. The processing cloud computer 114 can then transmit the cryptogram and the interaction identifier to the authentication service computer 116.

In step S18, an authentication service computer 116 can then send the cryptogram and the interaction identifier to the authorizing entity computer 118. This can be done automatically or can be done at the request of the authorizing entity computer 118.

In step S19, once the cryptogram is transmitted to the authorizing entity computer 118, the authorizing entity computer 118 may use the user device generated cryptogram to verify or validate the transaction. In some embodiments, the authorizing entity computer 118 can decrypt the cryptogram using the cryptographic key that is shared with the user device 102 to recover the inputs to the cryptogram. The inputs can include data such as the amount and the access data. The authorizing entity computer 118 can then identify the authorization request message corresponding to the current transaction by matching the interaction identifier from the authentication service computer and the interaction identifier in the authorization request message. The authorizing entity computer 118 can then determine if the data elements such as the amount and the access data obtained from the cryptogram match the corresponding data elements in the authorization request message. If they match, then the authorizing entity computer 118 can determine that the transaction is valid.

In other embodiments, as noted above, the inputs obtained, hashed and then signed using the cryptographic key (e.g., using an HMAC algorithm). Thus, in this case, it is not possible for the authorizing entity computer 118 to decrypt the inputs. However, authorizing entity computer 118 can verify the inputs (e.g., amount) by verifying the cryptogram (the signed hash) using cryptographic key. For example, the inputs can be hashed, and signed with the cryptographic key. The output can be compared to the cryptogram to validate it.

The authorizing entity computer 118 can authorize or decline the authorization request message for the transaction. In addition to verifying the cryptogram, it can determine if the account corresponding to the access data has sufficient funds or credit to pay for the current transaction. It can also determine if the existing interaction is potentially fraudulent.

It should be noted that variations on the above-described process steps can be within embodiments of the invention. For example, in other embodiments, the cryptogram may have been provided to the resource provider computer 106 along with the access data. In this case, the resource provider computer 106, instead of the processing cloud computer 114, can send the cryptogram to the authentication service computer 116. In other embodiments, the cryptogram may have been provided to the resource provider computer 106 before it receives the access data (e.g., using CNP or card not present messaging).

After confirmation and approval by the authorizing entity computer 118, in step S20, the authorizing entity computer 118 may generate and send an authorization response message back to the resource provider computer 106 via the processing network computer 112 and the transport computer 110 approving of the transaction.

At the end of the day or at any other suitable period of time, a clearing and settlement process between the transport computer 110, the processing network computer 112, and the authorizing entity computer 118 can be performed.

Other embodiments are also possible. In one alternative embodiment, the processing cloud computer 114 can tokenize the captured access data, then replace the access data with a token (an example of a derivative of the access data).

In another embodiment, the user device generated cryptogram can be verified by processing network computer 112 on behalf of the authorizing entity computer 118.

Although the invention has been described in the context of a card-not-present transaction with an e-commerce merchant, embodiments of the invention can apply in other contexts. For example, embodiments of the invention can be used in person-to-person push payment transactions.

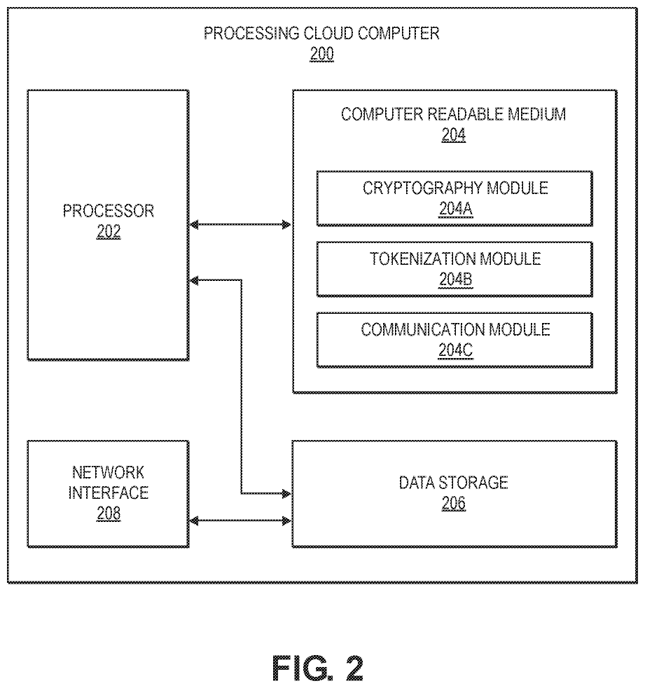

FIG. 2 shows a block diagram of a processing cloud computer 200 according to an embodiment. The processing cloud computer 200 may comprise a processor 202, which may be coupled to a computer readable medium 204, data storage 206, and a network interface 208.

The computer readable medium 204 may comprise several software modules including a cryptography module 204A, tokenization module 204B, and a communication module 204C.

The cryptography module 204A may include any suitable encryption / decryption algorithms to encrypt data in embodiments of the invention. Suitable data encryption/decryption algorithms may include DES, triple DES, AES, etc. It may also store encryption keys that can be used with such encryption/decryption algorithms. The cryptography module 204A may utilize symmetric or asymmetric encryption techniques to encrypt and/or verify data. Keys that may be used by the cryptography module 204A may be securely stored in the data storage 606.

The tokenization module 204B may comprise code that causes the processor 202 to provide access tokens. For example, the tokenization module 204B may contain logic that causes the processor 202 to generate a payment token and/or associate the payment token or cryptogram with a set of user credentials. The tokenization module 204B may comprise code that causes the processor 202 to validate token requests before a payment token is provided. A token record may then be stored in a token record database indicating that the token is associated with a certain user or a certain set of credentials.

The communication module 204C may comprise code that causes the processor 202 to generate messages, forward messages, reformat messages, and/or otherwise communicate with other entities.

Another module that can be present in the computer readable medium 204 can include a unique interaction identifier module for generating unique identifiers for interactions.

The computer readable medium 204 may comprise code executable by the processor 202, to perform operations comprising: receiving encrypted data from a user device operated by a user via a secure kernel on a communication device, after the user interacts with a resource provider computer in an interaction; decrypting the encrypted data to recover access data, and a cryptogram; transmitting, to the resource provider computer, an interaction identifier and the access data or a derivative of the access data, wherein the resource provider computer thereafter transmits an authorization request message comprising the access data or derivative thereof to an authorizing entity computer; transmitting, to the authorizing entity computer, the cryptogram, wherein the authorizing entity computer receives the authorization request message and the cryptogram, and authorizes or declines the interaction based on data in the authorization request message and the cryptogram.

The data storage 206 may store tokens and their associated credentials in a database. It can also store addresses associated with authentication server computers, authorizing entity computers, and resource provider computers. The data storage 206 may store data in a database such as an Oracle™ database.

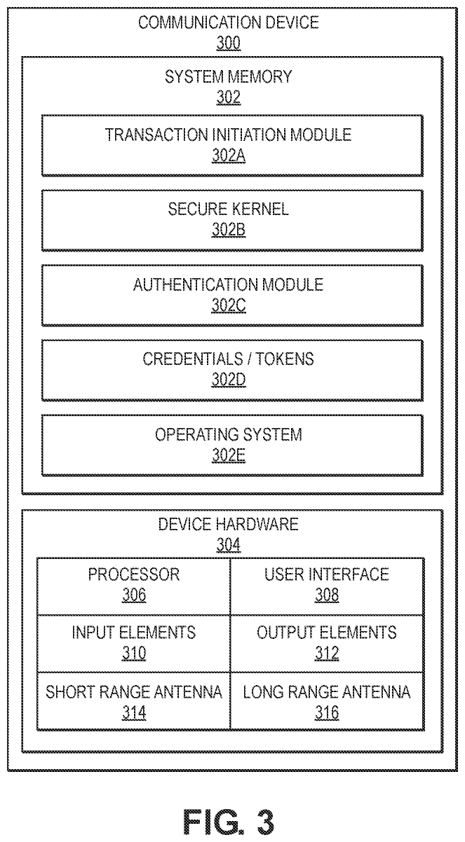

FIG. 3 illustrates a communication device 300 according to an embodiment. Communication device 300 may include device hardware 304 coupled to a system memory 302.

Device hardware 304 may include a processor 306, a short range antenna 314, a long range antenna 316, input elements 310, a user interface 308, and output elements 312 (which may be part of the user interface 308). Examples of input elements may include microphones, keypads, touchscreens, sensors, etc. Examples of output elements may include speakers, display screens, and tactile devices. The processor 306 can be implemented as one or more integrated circuits (e.g., one or more single core or multicore microprocessors and/or microcontrollers), and is used to control the operation of communication device 300. The processor 306 can execute a variety of programs in response to program code or computer-readable code stored in the system memory 302, and can maintain multiple concurrently executing programs or processes.

The long range antenna 316 may include one or more RF transceivers and/or connectors that can be used by communication device 300 to communicate with other devices and/or to connect with external networks. The user interface 308 can include any combination of input and output elements to allow a user to interact with and invoke the functionalities of communication device 300. The short range antenna 314 may be configured to communicate with external entities through a short range communication medium (e.g., using Bluetooth, Wi-Fi, infrared, NFC, etc.). The long range antenna 316 may be configured to communicate with a remote base station and a remote cellular or data network, over the air.

The system memory 302 can be implemented using any combination of any number of non-volatile memories (e.g., flash memory) and volatile memories (e.g. DRAM, SRAM), or any other non-transitory storage medium, or a combination thereof media. The system memory 302 may store computer code, executable by the processor 306, for performing any of the functions described herein.

The system memory 302 may also store an application 302A, a secure kernel module 302B, an authentication module 302C, credentials/tokens 302D, and an operating system 302E, The application 302A may include instructions or code initiating and conducting a transaction with an external device such as the resource provider computer. The secure kernel module 302B may comprise code, executable by the processor 306, to capture and encrypt access data and a cryptogram from the user device. It may also include code, executable by processor 306, to transmit encrypted data. It may also include code, executable by the processor 306, to cause the communication device 300 to receive data from an external user device. The authentication module 302C may comprise code, executable by the processor 306, to authenticate a user. This can be performed using user secrets (e.g., passwords) or user biometrics.

System memory 302 may also store credentials and/or tokens 302D. Credentials may also include information identifying the communication device 300 and/or the user of the communication device 300.

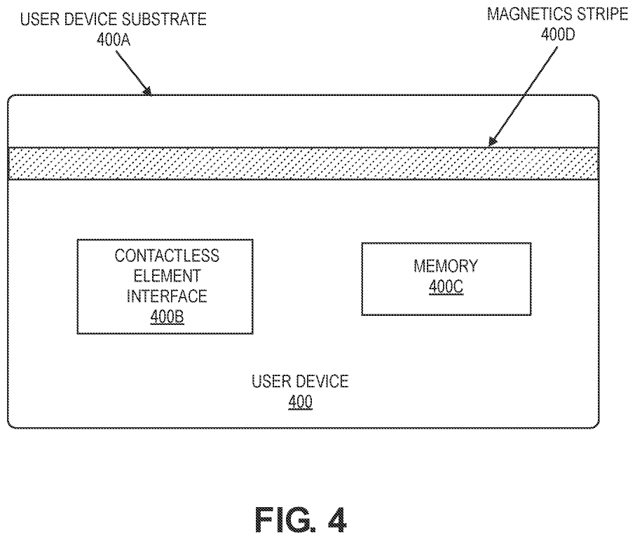

FIG. 4 shows a user device 400 in the form of a card. The user device 400 comprises a substrate 400A such as a plastic substrate. A contactless element 400B for interfacing with a data access or data transfer device may be on or embedded within the user device substrate 400A. The contactless element 400B may include a chip and may include the capability to communicate and transfer data using near field communications (NFC) technology or other short range communications technology. The user device 400 may be assigned to a user by an authorizing entity, such as an issuer bank.

The user device 400 may also include a memory 400C, which may store user information such as an account number, expiration date, and a username. In some cases, the memory 400C may include a secure element, and/or may also store information such as access data. Information in the memory 400C can be transmitted by the user device 400 to another device using the contactless element interface 400B. Information may also be printed or embossed on the substrate 400A. The substrate 400A may also have a magnetic stripe 400D on it.

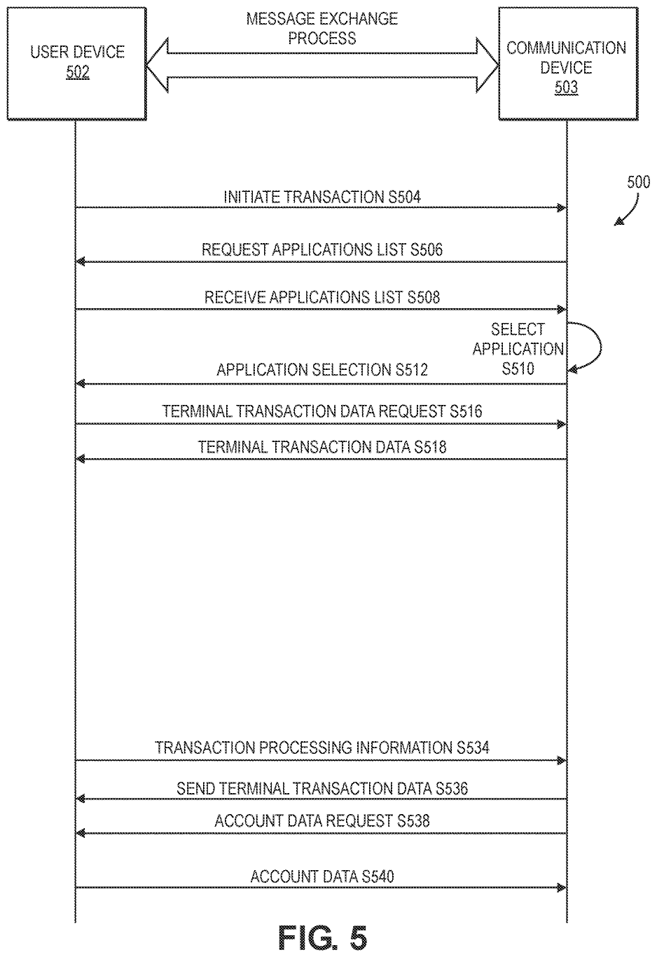

FIG. 5 shows a message exchange process 500 between user device 502 and communication device 503. The process can be used in, for example, step S8 of FIG. 1.

Prior to performing the message exchange process, an authorizing entity (e.g., an issuer, the user's bank, etc.) may initialize the user device 502 with a number of data fields (e.g., as part of a process for personalization of the user device 502). The user device 502 may be configured with one or more applications. In some embodiments, the issuer may assign a priority to these applications. By way of example, one application (e.g., a U.S. payment or access application) on a user device 502 can be associated with a particular transaction processing protocol and may be assigned a high priority. The user device 502 may store additional sensitive user device data such as a PAN (primary account number), a CVV, an expiration date, and any other suitable information.

At step S504, a user can subsequently use the user device 502 to initiate a transaction with the communication device 503. The user may hold the user device 502 near the communication device 503, such that both devices may mutually detect each other. The user may present (e.g., tap, hold near, etc.) the user device 502 to the communication device 503 to exchange data with the communication device 503.

At step S506, during a process for exchanging data between the user device 502 and the communication device 503, the user device 502 may provide the communication device 503 with a list of available applications including at least a first application and a second application. In an interaction, the communication device 503 may send an available applications request message to the user device 502. The available applications request message can request information regarding which applications (e.g., a list of application identifiers (AIDs)) are available on the user device 502. In some embodiments, the available applications request message may be in the form of a SELECT PPSE command.

At step S508, the user device 502 then identifies, from a memory of the user device 502, available applications including at least a first application and a second application. The user device 502 then provides (e.g., transmits) an initial or first available applications response message to the communication device 503. The available applications response message includes the list of the applications (e.g., a list of AIDs) available at the user device 502 in a SELECT PPSE response in response to receiving the SELECT PPSE command. The available applications response message can comprise an application list comprising at least the first application and the second application. The application list can be ordered according to a first priority and a second priority to indicate a preference for the communication device 503 to use the first application over the second application to process the interaction.

As shown in step S510, the communication device 503 selects an application from the received application list, and then transmits the selection of the application in a select AID message to the user device 502 (step S512). In some embodiments, the communication device 503 selects the application highest in the list (e.g., the application associated with the highest priority, in this case the first application). If the interaction is a payment transaction, then this process for application selection may conform to a payment standard such as EMV 1.0 and/or EMV 2.0.

At step S516, the user device 502 may transmit a request for terminal transaction data (e.g., a PDOL request).

At step S518, responsive to the request for terminal transaction data, the communication device 503 may send transaction data to the user device 502. In some embodiments, the communication device 503 may send such data in a processing options data object list (PDOL) message to the user device 502. The selected application (e.g., the first application or international application) may receive the data via the PDOL message.

At step S534, the user device 502, upon receiving the application selection message at step S518, may send a terminal transaction data request to request transaction data from the communication device 503. In some embodiments, the terminal transaction data request may be in the form of a “Select AID Response” and may include application identifier (AID) and file control information (FCI) associated with the selected AID as the dedicated file name. The terminal transaction data request may include a list of transaction data identifiers to request the appropriate data from the communication device 503. The list of transaction data identifiers can be in the form of a processing options data object list (PDOL).

The transaction data requested by the user device 502 for the transaction may include terminal processing options (TPO), an amount, and other information. In addition, the transaction data may include one or more dynamic data elements (e.g., a random number).

At step S536, after receiving the terminal transaction data request from user device 502, the communication device 503 may send the terminal transaction data to the user device 502. In some embodiments, the terminal transaction data may be sent in the form of a get processing options (GPO) command, and may include the requested terminal transaction data in a processing options data object list (PDOL). The terminal transaction data (e.g., Transaction Processing Options (TPO)) may include a TPO indicator that indicates which transaction data types the communication device 503 supports.

Once the user device 502 receives the terminal transaction data, the user device 502 may obtain relevant credentials (e.g., card credentials), and may send a set of transaction processing information to the communication device 503 (arrow not shown in FIG. 5). In some embodiments, the transaction processing information can be sent in the form of a “get processing options” (GPO) response. In some embodiments, the transaction processing information may include one or more application file locators (AFLs) that can be used as file addresses by communication device 503 to read account data stored on the user device 502, and an application interchange profile (AIP) that can be used to indicate the capabilities of the payment application.

The transaction processing information may include any credentials for the transaction including a cryptogram generated using transaction information, Track-2 equivalent data (e.g., PAN, expiration date), and/or additional data. For example, the cryptogram may be generated using transaction information, which may include a dynamic data element (e.g., the random number), the user device 502 identifier (e.g., a PAN), and optionally other information such as a session identifier, a value such as a zero dollar amount, and a transaction counter. The transaction processing information may also include issuer application data (IAD), a form factor indicator (FFI), card transaction qualifiers (CTQ), cryptogram information data (CID), and/or an application PAN sequence number (PAN). In some embodiments, the issuer application data (IAD) may include a length indicator indicating the length of the IAD, a cryptogram version number (CVN) indicating the version of the transaction cryptogram, a derived key indicator (DKI) that can be used to identify a master key (e.g., a master key associated with the issuer), and/or card verification results (CVR).

In some embodiments, after the communication device 503 receives the transaction processing information, in step S538, the communication device 503 may send an account data request to the user device 502 to read additional account data that may be stored on the user device 502. In some embodiments, the account data request may be in the form of a “read record” command, and may include an application file locator (AFL) indicating a location of the account data that the communication device 503 is attempting to read. The AFL included in the account data request may correspond to an AFL in the transaction processing information that was provided to the communication device 503 from user device 502.

In response to receiving the account data request from the communication device 503 in step S540, the user device 502 may send account data stored at the location indicated by the AFL to the communication device 503. In some embodiments, the account data may be sent in the form of a “read record” response. The account data may include, for example, application usage control that indicates the issuer's restrictions on usage and services allowed for the application, the cardholder's name, customer exclusive data, issuer country code, and/or other account related data that is accessible at the AFL location and is stored in the user device 502. The account data, transaction processing information, and other data received by the communication device 503 in previous steps may be subsequently used by the communication device 503 to complete the payment transaction.

At some point, the user may remove the user device 502 from the communication device 503, or otherwise disengage the user device 502 from the communication device 503. Upon removal or disengagement, the user device 502 may be powered off which also powers off the volatile memory of the user device 502, clearing the flag previously set on the user device 502.

Any of the software components or functions described in this application, may be implemented as software code to be executed by a processor using any suitable computer language such as, for example, Java, C++, or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention may become apparent to those skilled in the art upon review of the disclosure. The scope of the invention can, therefore, be determined not with reference to the above description, but instead can be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method comprising:
receiving, by a processing cloud computer, encrypted data from a user device operated by a user via a secure kernel on a communication device, after the user interacts with a resource provider computer in an interaction;
decrypting, by the processing cloud computer, the encrypted data to recover access data, and a cryptogram;
transmitting, by the processing cloud computer to the resource provider computer, an interaction identifier and the access data or a derivative of the access data, wherein the resource provider computer thereafter transmits an authorization request message comprising the access data or derivative thereof to an authorizing entity computer; and
transmitting, by the processing cloud computer to the authorizing entity computer, the cryptogram,
wherein the authorizing entity computer receives the authorization request message and the cryptogram, and authorizes or declines the interaction based on data in the authorization request message and the cryptogram.

2. The method of claim 1, wherein the access data or the derivative of the access data is the access data.

3. The method of claim 2, wherein the access data comprises a primary account identifier.

4. The method of claim 1, wherein the resource provider computer operates a host site, which the user interacts with in the interaction.

5. The method of claim 4, wherein the host site provides a value for the interaction, and wherein the cryptogram is based on at least the access data and the value.

6. The method of claim 1, wherein the secure kernel and the processing cloud computer share a first set of zone encryption keys, and the resource provider computer and the processing cloud computer share a second set of zone encryption keys.

7. The method of claim 1, wherein the communication device further comprises an application, wherein the communication device interacts with the resource provider computer via the application.

8. The method of claim 7, wherein the application is a Web browser.

9. The method of claim 7, wherein the application is a resource provider application and the resource provider computer is an application server computer that supports the resource provider application.

10. The method of claim 1, wherein the cryptogram is transmitted to the authorizing entity computer in a communication via an authentication server computer.

11. The method of claim 10, wherein the communication further comprises the access data.

12. The method of claim 11, wherein the authentication server computer, the processing cloud computer, or the authorizing entity computer authenticates the user or the communication device after receiving the cryptogram.

13. The method of claim 1, wherein the authorizing entity computer validates the cryptogram before authorizing the interaction.

14. The method of claim 13, wherein the authorizing entity computer validates the cryptogram by generating another cryptogram by encrypting the access data or derivative thereof and a value in the authorization request message, and comparing the cryptogram to the another cryptogram to determine if a match is present.

15. A processing cloud computer comprising:
a processor; and
a computer readable medium comprising code executable by the processor, to perform operations comprising:
receiving encrypted data from a user device operated by a user via a secure kernel on a communication device, after the user interacts with a resource provider computer in an interaction;
decrypting the encrypted data to recover access data, and a cryptogram;
transmitting, to the resource provider computer, an interaction identifier and the access data or a derivative of the access data, wherein the resource provider computer thereafter transmits an authorization request message comprising the access data or derivative thereof to an authorizing entity computer; and
transmitting, to the authorizing entity computer, the cryptogram,
wherein the authorizing entity computer receives the authorization request message and the cryptogram, and authorizes or declines the interaction based on data in the authorization request message and the cryptogram.

16. A method comprising:
receiving, by an authorizing entity computer, an authorization request message from a processing network computer;
receiving, by the authorizing entity computer in a communication, a cryptogram from a processing cloud computer, wherein the cryptogram as obtained from a user device operated by a user via a secure kernel on a communication device;
validating, by the authorizing entity computer, the cryptogram;
authorizing, by the authorizing entity computer, the authorization request message based in part on the validating of the cryptogram; and
responsive to authorizing, transmitting, by the authorizing entity computer, an authorization response message to the processing network computer.

17. The method of claim 16, wherein the cryptogram is received from the processing cloud computer via an authentication service computer.

18. The method of claim 16, further comprising:
matching the authorization request message with the communication using a unique interaction identifier.

19. The method of claim 16, wherein the user device is a card and the communication device is a tablet computer, a mobile phone, or a laptop computer.

20. The method of claim 16, wherein the authorizing entity computer is an issuer computer.
